(19) United States
(12) Patent Application Publication
(10) Pub. No.: US 2008/0036870 A1
(43) Pub. Date: Feb. 14, 2008

(54) DIGITAL CAMERA

(76) Inventor: Tetsuji Uezono, Kanagawa (JP)

Correspondence Address: Pamela R. Crocker;Patent Legal Staff, Eastman Kodak Company, 343 State Street, Rochester, NY, 14650-2201, US

(21) Appl. No.: 11/558,085

(22) Filed: Nov. 9, 2006

(30) Foreign Application Priority Data
Aug. 8, 2006 (JP) 2006-215610

(51) Int. Cl. H04N 5/228

(52) U.S. Cl. 348/222.1; 348/E09.006

(57) ABSTRACT

In order to automatically determine a scene, a probability that a presumed target which is a characteristic target in an imaging scene is present is calculated in advance for each imaging scene as scene reliability. In order to calculate the scene reliability, a color characteristic and a brightness characteristic of the presumed target of each imaging scene is stored in a digital camera as a scene characteristic in advance. When the scene reliability is calculated, a preview image is divided into a plurality of blocks and a representative brightness value and a representative color value of each block are calculated as block characteristics. The scene reliability is then calculated based on a comparison between the calculated block characteristics and the scene characteristic of each imaging scene.

### PRIORITY INFORMATION

This application claims priority to Japanese Patent Application No. 2006-215610 filed on Aug. 8, 2006, which is incorporated herein by reference in its entirety.

### FIELD OF THE INVENTION

The present invention relates to a digital camera in which an imaging scene suitable for a current imaging situation can be selected from a plurality of previously specified imaging scenes, and set as a preferred scene.

### BACKGROUND OF THE INVENTION

To date, a great number of cameras having an imaging-scene function have been marketed. The imaging-scene function is for automatically setting various kinds of imaging conditions in accordance with the imaging situation, in the case where an imaging scene suitable for a current imaging situation is selected from a plurality of previously specified imaging scenes and set as a preferred scene. For example, in the case where a person is imaged, a portrait scene, which is suitable for imaging a person, is selected by a user and set as a preferred scene. After the portrait scene has been set, the camera automatically sets various kinds of imaging conditions, such as the values of the diaphragm stop, the shutter speed, and color-correction-processing control parameters, to the values that are suitable for imaging a person.

While the use of the imaging-scene function enables more preferred image capturing, it has been a problem that user's manual selection of an imaging scene for each image capturing is complex. Thus, conventionally, a great number of techniques have been proposed that are related to automatic scene determination in which a camera automatically determines an imaging scene suitable for a current imaging situation.

The automatic scene determination presumes a current imaging situation, based on information such as a target distance and environmental brightness, and determines a preferred imaging scene. In addition, as disclosed in JP Publication No. 2003-18453 and JP Publication No. 2006-92137, a technique is also known in which, based on a preview image, the kind of a current light source and the relationship between the light source and a main target (whether the target is backlit or not) are determined, and the determination is utilized for the automatic scene determination. Additionally, a technique is also known in which it is determined whether or not the portrait scene is appropriate, based on whether or not a face recognition unit provided in a camera can recognize a person's face in a preview image. By utilizing the foregoing techniques, the accuracy of the automatic scene determination can be raised to some extent.

### SUMMARY OF THE INVENTION

However, conventional automatic scene determination techniques as described above have not been able to identify the kinds of targets other than a person. Therefore, except for the portrait scene, it has not been made possible to appropriately determine an imaging scene in which the target is somewhat characterized, e.g., a text scene which is suitable for imaging a document. Accordingly, in the automatic scene determination, erroneous determination has been likely to be produced.

Thus, it is an advantage of the present invention to provide an index with which the accuracy of the automatic scene determination can be enhanced.

A digital camera according to the present invention, in which an imaging scene suitable for a current imaging situation can be selected among a plurality of predetermined imaging scenes and set as a preferred scene, is characterized by including an imaging unit which optoelectrically performs conversion of a target image focused by an imaging optical system so as to obtain a captured image; a block dividing unit which divides the captured image into a plurality of blocks and calculates as block characteristics a representative brightness value and a representative color value of each block; a storage unit which, for each imaging scene, preliminarily stores as scene characteristics at least one of a color characteristic and a brightness characteristic of a presumed target which is a characteristic target in each imaging scene; and a reliability calculation unit which, for each imaging scene, calculates as a scene reliability a probability that the presumed target is captured within the captured image, based on a comparison between the block characteristics and the scene characteristics.

In a preferred embodiment, the reliability calculation unit calculates the scene reliability, based on the number of blocks, among the plurality of blocks that configures the captured image, that each have the same characteristics as the scene characteristics.

In a preferred embodiment, the scene characteristics include a color area and a brightness area of the presumed target, and the reliability calculation unit calculates the scene reliability, based on the number of blocks, among the plurality of blocks that configure the captured image, whose representative color values fall within the color area of the presumed target and whose representative brightness values fall within the brightness area of the presumed target.

In a preferred embodiment, with regard to an imaging scene in which a plurality of presumed targets exist that have color characteristics that are different from one another and brightness characteristics that are different from one another, the storage unit stores, as the scene characteristic of the imaging scene, the color characteristic and the brightness characteristic of each presumed target, as target characteristics, and the reliability calculation unit calculates the probability level of existence of each presumed target, based on the number of blocks that each have the same characteristics as the target characteristics of said presumed target, and calculates the scene reliability, based on the sum of the calculated probability levels for each presumed target.

In another preferred embodiment, in the case where scene reliability levels, calculated based on the number of blocks, for two or more imaging scenes that are established under respective conditions that are contrary to one another are all the same as or higher than a specific reference value, the reliability calculation unit makes all the scene reliability levels of the two or more imaging scenes zero.

In another preferred embodiment, the storage unit stores a color area of candlelight, a low-brightness block number that is the number of low-brightness blocks, and a color reference value of candlelight, as the scene characteristic of a candlelight scene suitable for imaging in candlelight, and in the case where the representative color value of a maximal-brightness block among the plurality of blocks that configures the captured image falls within the color area of candlelight and number of the low-brightness blocks is the same as or larger than the low-brightness block number, the reliability calculation unit calculates the scene reliability, based on the ratio of the representative color value of a maximal-brightness block to the color reference value of candlelight.

In another preferred embodiment, a proposal unit is further included which, as a candidate for the preferred scene, proposes to a user an imaging scene for which scene reliability that is the same as or higher than a specific reference value is calculated.

According to the present invention, for each imaging scene, a probability that the presumed target is captured within the captured image is calculated as scene reliability, based on a comparison between the block characteristics and the scene characteristics. By use of the scene reliability for each imaging scene, the current target type can be presumed to some extent. Accordingly, by utilizing the scene reliability, the accuracy of the automatic scene determination can be raised.

### BRIEF DESCRIPTION OF THE DRAWINGS

Preferred embodiments of the present invention will be described in detail based on the following figures, wherein:

FIG. 1 is a block diagram illustrating the configuration of a digital camera which is an embodiment of the present invention;

FIG. 2 is a chart for explaining a T space;

FIG. 3 is a chart for explaining a text scene;

FIG. 4 is a chart representing an example of a text color area;

FIG. 5 is a chart representing an example of a text reliability curve;

FIG. 6 is a chart for explaining a flower scene;

FIG. 7 is a chart representing examples of a leaf color area and a petal color area;

FIG. 8 is a chart representing an example of a leaf reliability curve;

FIG. 9 is a chart representing an example of a petal reliability curve;

FIG. 10 is a chart for explaining a snow scene;

FIG. 11 is a chart for explaining a beach scene;

FIG. 12 is a chart representing examples of a snow color area and a beach color area;

FIG. 13 is a chart representing an example of a snow reliability curve;

FIG. 14 is a chart representing an example of a beach reliability curve;

FIG. 15 is a chart for explaining a candlelight scene;

FIG. 16 is a chart representing an example of a candle color area; and

FIG. 17 is a view illustrating an example of a proposal mode of a preferred scene candidate.

### DETAILED DESCRIPTION OF THE INVENTION

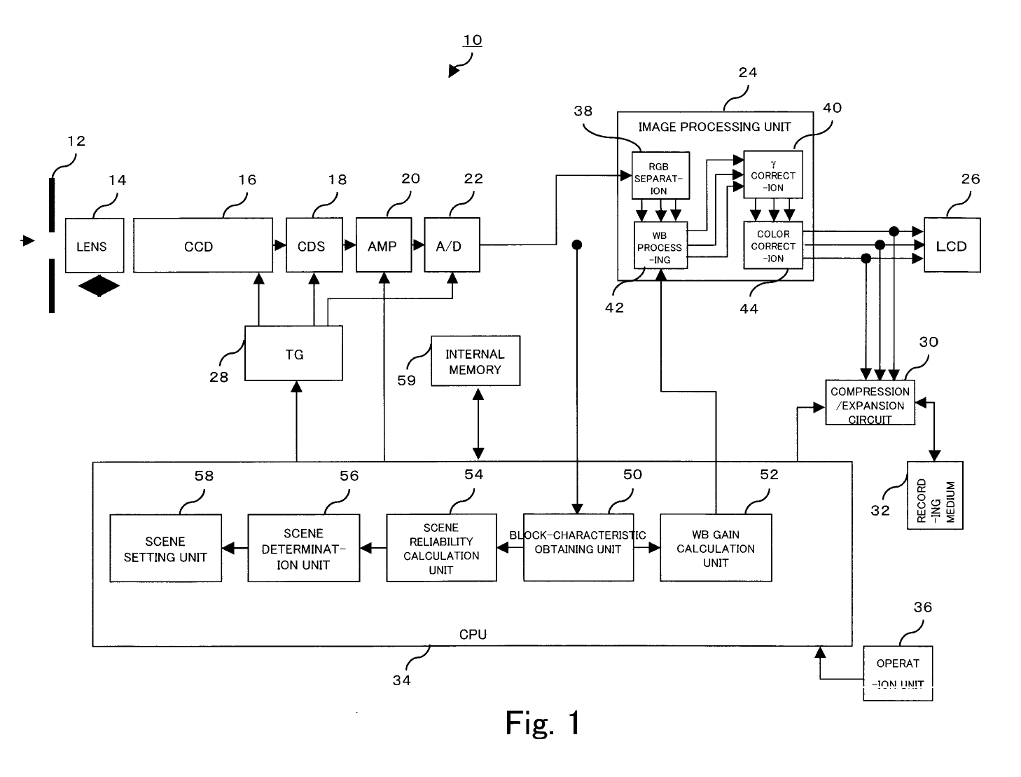

An embodiment of the present invention will be explained below with reference to the drawings. FIG. 1 is a block diagram illustrating the configuration of a digital camera 10 which is an embodiment of the present invention. In the digital camera 10, an imaging scene which is suitable for a current imaging situation can be set, as a preferred scene, selectively from a plurality of preliminarily specified imaging scenes. In other words, in a digital camera, a portrait scene suitable for imaging a person, a text scene suitable for imaging a document, a flower scene suitable for imaging a flower, and the like are preliminarily specified. When, in image capturing, one imaging scene among the preliminarily specified imaging scenes is selected and set as a preferred scene, the digital camera 10 automatically sets imaging conditions with which a preferred imaging for the imaging scene is enabled. In other words, when the portrait scene is selected and set, the shutter speed, the diaphragm stop, color-correction-processing parameters, and the like are automatically adjusted to values suitable for imaging a person.

In this situation, the selection and the setting of the preferred scene is not only manually executed by the user, but also automatically executed in the camera. In other words, in the case where no setting for the preferred scene is executed by the user, the digital camera 10 determines an imaging scene suitable for the current imaging situation, based on information such as a target distance, environmental brightness, the result of face recognition, and the like. Next, the digital camera sets an imaging scene, which is determined to be most suitable for the current imaging situation, as the preferred scene. For the automatic determination of the preferred scene, the digital camera 10 according to the present embodiment calculates scene reliability described in detail later. The scene reliability is an index that, for each imaging scene, indicates the level of probability of characteristic-target existence. The configuration of the digital camera 10 will be explained below, with the description about the calculation of the scene reliability as a main subject.

A light beam from a target, which is inputted through a diaphragm member 12 and a lens 14, focuses on a CCD 16 as an image-capturing element. The CCD 16 converts the inputted light beam into an electrical signal and outputs the electrical signal as an image signal. The timing for the optoelectric conversion by the CCD 16 is controlled by a CPU 34, through a timing generator (TG) 28. Generally, the CCD 16 always alternates accumulation and discharge of electric charges at a constant duration so as to obtain a preview image to be displayed on a LCD 26. Additionally, when the user issues an imaging instruction, the CCD 16 temporarily stops the optoelectric conversion for obtaining the preview image and, after accumulating electric charges for an exposure time necessary for actual image capturing, discharges the electric charges.

The image signal outputted from the CCD 16 receives predetermined analog signal processing by a correlated double sampling (CDS) circuit 18 and amplification processing by an amplifier (AMP) 20, and is then converted by an A/D converter (A/D) 22 into digital data. The digital data is outputted to an image processing unit 24 and a block-characteristic obtaining unit 50. In the image processing unit 24, the image data is separated by an RGB separation unit 38 into three color components, i.e., an R component, a G component, and a B component. The separated data is conveyed sequentially to a white balance (WB) processing section 42, a γ-correction section 40, and a color correction section 44 so as to receive predetermined image processing. Among the forgoing sections, the WB processing section 42 performs WB processing, by multiplying the corresponding color component data items by three kinds of WB gains calculated in a WB gain calculation unit 52, i.e., R gain, G gain, and B gain.

The image data to which the image processing has been applied is outputted to the LCD 26 and a compression/expansion circuit 30. The LCD 26 electrically displays the image data to which the image processing has been applied. Image data to be displayed on the LCD 26 includes a preview image and a recorded image to be recorded in a recording medium 32 described later. When displaying a preview image, the LCD 26 functions as an electronic viewfinder that displays a target that can be image-captured. In contrast, when displaying a recorded image recorded in the recording medium 32, the LCD 26 functions as a playback monitor that reproduces and displays a recorded image.

The compression/expansion circuit 30 applies compression processing to the inputted image data. The image data to which the compression processing has been applied is recorded in the recording medium 32 as a recorded image. The recorded image recorded in the recording medium 32 receives expansion processing, executed in response to an instruction from the user, by the compression/expansion circuit 30 and is then displayed on the LCD 26.

The block-characteristic obtaining unit 50 divides the inputted image data into a plurality of blocks and calculates, as block characteristics, the representative brightness value and the representative color value of each block.

The calculated block characteristics are inputted to the WB gain calculation unit 52 and a scene-reliability calculation unit 54. Based on the inputted block characteristics, the WB gain calculation unit 52 presumes the kind of the light source for the image data and calculates WB gain necessary for the WB processing. The calculated WB gain is inputted to the foregoing WB processing section 42.

Based on the block characteristics of the preview image, the scene-reliability calculation unit 54 calculates the scene reliability that is an index to be utilized for automatically determining an imaging scene. The scene reliability is calculated for an imaging scene that cannot readily be determined based only on a target distance, environmental brightness, whether or not a person exists, and the like, and in which a characteristic target may exist. In the case where a plurality of imaging scenes described above exist, scene reliability is calculated for each of the imaging scenes. In the present embodiment, the scene reliability is calculated for each of the text scene suitable for imaging a document, the flower scene suitable for imaging a flower, the beach scene suitable for imaging on a beach, a snow scene suitable for imaging on the snow, and a candlelight scene suitable for imaging in candlelight. The details of the scene reliability will be described in detail later.

The calculated scene reliability is inputted to a scene determination unit 56. In the case where no preferred scene is set by the user, the scene determination unit 56 automatically determines an imaging scene suitable for the current imaging situation. The automatic scene determination is performed based not only on the foregoing scene reliability but also on information such as a target distance, environmental brightness, and whether or not a person exists. In this situation, as a target distance, distance-measurement information obtained through an AF controller (unillustrated) is utilized. Environmental brightness is calculated based on the total brightness value of a preview image, the result of detection by a photometry sensor (unillustrated), and the like. Whether or not a person exists is determined based on whether or not a face recognition circuit (unillustrated) can recognize a person's face in a preview image. The result of imaging-scene determination is inputted to a scene setting unit 58.

The scene setting unit 58 determines imaging conditions corresponding to the imaging scene that is determined as a preferred scene by the scene determination unit 56 or the imaging scene that is designated as a preferred scene by the user, through an operation unit 36, and adjusts respective control parameters for the units so that image capturing under the imaging conditions is enabled. Specifically, in accordance with the imaging scene, the scene setting unit 58 determines whether or not the flash is necessary at the time of image capturing and adjusts the shutter speed, parameters for image processing performed by the image processing unit, and the like.

An internal memory 59 stores scene-characteristics information that is required for the scene-reliability calculation, various kinds of information items on various threshold values that are required for performing automatic scene determination, imaging conditions corresponding to the imaging scene, and the like. The scene-reliability calculation unit 54 and the other units, as may be necessary, refer to the various kinds of information items stored in the internal memory 59 and perform calculation.

Next, the scene reliability utilized for the automatic scene determination will be explained. As described above, in the case where no preferred scene is selected and set by the user, the scene determination unit 56 automatically determines and sets a preferred scene.

In the automatic scene determination, a target distance, environmental brightness, whether or not a person exists, and the like, are considered. To date, a great number of techniques have been known in which, based on a target distance, environmental brightness, and the like, an imaging scene is automatically determined. In addition, a technique is also known in which, based on the color characteristic and the brightness characteristic of a preview image, the kind of a light source and the relationship between the light source and a main target (whether the target is backlit or not) are determined, and the determination result is utilized for the automatic scene determination. Furthermore, a technique is also proposed in which, in the case where a face recognition unit provided in a camera recognizes a person face in a preview image, it is automatically determined that the scene is a portrait scene. By utilizing the foregoing techniques, the accuracy of the automatic scene determination can be raised to some extent.

However, imaging scenes also exist that cannot be readily determined based only on a target distance, environmental brightness, and whether or not a person exists. In particular, it has been difficult to determine, by conventional techniques, an imaging scene in which the kind of target to be presumed is characteristic. For example, it has been difficult to distinguish the text scene suitable for imaging a document from the flower scene suitable for imaging a flower, based on a target distance, environmental brightness, and the like. In other words, in the case where a document is imaged as well as in the case where a flower is imaged, a situation most frequently occurs in which the target distance is relatively short, the environmental brightness is relatively high, and no person exists. The greatest difference between the text scene and the flower scene lies on the kinds of targets to be presumed. Accordingly, if it is impossible to presume to some extent the kind of target existing in a preview image, it is difficult to explicitly distinguish the text scene from the flower scene. In addition, it has been difficult to distinguish a snow scene or a beach scene from another imaging scene, e.g. a landscape scene suitable for imaging a distant landscape, based on a target distance, environmental brightness, the kind of light source, and the like.

In this regard, in the present embodiment, with regard to some imaging scenes, the scene reliability levels are calculated and utilized for the automatic scene determination. The scene reliability is an index that, for each imaging scene, indicates the level of probability of characteristic-target existence. In addition, hereinafter, a characteristic target in an imaging scene is referred to as a “presumed target”. In this situation, the presumed target, i.e., the characteristic target in a specific imaging scene, is a target that is presumed to definitely exist in the specific imaging scene. Thus, the presumed target is not necessarily a main target. For example, in the beach scene suitable for imaging on a beach, the “beach” is the presumed target. In the text scene suitable for imaging a document, the “document” is the presumed target.

As described above, the scene determination unit 56 performs scene determination not only based on the scene reliability, but also in consideration of a target distance and environmental brightness. Accordingly, for example, when the target distance is long, it may be determined that the current situation does not correspond to that of the text scene, even in the case where the scene reliability of the text scene is high.

In order to calculate the scene reliability, at least one of the color characteristic and the brightness characteristic of the presumed target in each imaging scene is preliminarily stored, as a scene characteristic, in the internal memory 59 of the digital camera 10. The scene-reliability calculation unit 54 calculates the scene reliability, by comparing the scene characteristic with block characteristics (a representative color value and a representative brightness value of each of blocks) of a preview image. Here, the reason why, in calculating the scene reliability, not the brightness value and the color value of each pixel, but the brightness value and the color value of each block are utilized is to reduce the calculation speed.

The more specific calculation procedure for the scene reliability differs depending on the kind of imaging scene. Thus, hereinafter, for each imaging scene, the specific calculation procedure for the scene reliability will be explained.

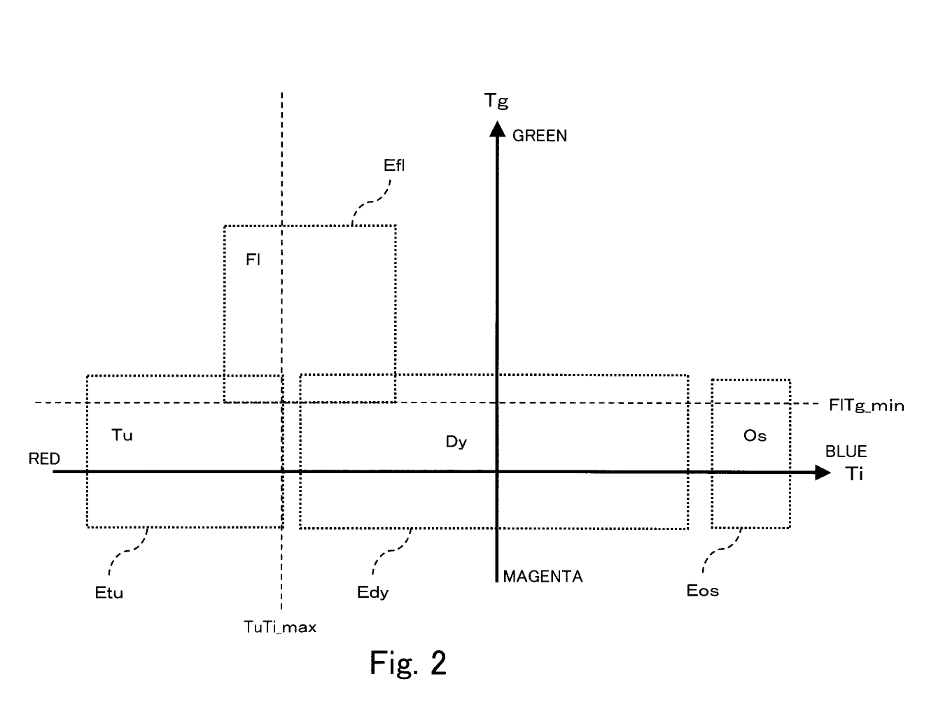

In the first place, a color-value representation mode according to the present embodiment will be explained in brief. In the present embodiment, color values are represented by means of a color space called a “T space”. As represented in FIG. 2, in the T space, the Ti axis, which is an abscissa, denotes blue to red (color temperature), and the Tg axis, which is an ordinate, denotes magenta to green. In the present embodiment, a color value is represented as a coordinate value in the T space. In addition, in the case where a color value represented by means of an RGB value is converted into a coordinate value, the following equation (1) is utilized.

$$\begin{matrix}[ Equation 1 ] & \\ ( \begin{matrix}Tl \\ Tg \\ Ti\end{matrix} ) = ( \begin{matrix}1 / 4 & 1 / 2 & 1 / 4 \\ - 1 / 4 & 1 / 2 & - 1 / 4 \\ - 1 / 2 & 0 & 1 / 2\end{matrix} ) ( \begin{matrix}R \\ G \\ B\end{matrix} ) & ( 1 )\end{matrix}$$

where Tl denotes the brightness of a block, and Tg and Ti denote color differences of the block. In the T space, colors are represented by utilizing Tg and Ti as the ordinate and the abscissa, respectively. In addition, the linear-transformation matrix utilized here is simply an example, and it goes without saying that another type of matrix may be utilized.

Additionally, in FIG. 2, the rectangles illustrated by broken lines are color areas, of various types of light sources, represented as examples. In other words, the rectangles Etu, Edy, Eos, and Efl represent the color areas of tungsten light, daylight, shade, and fluorescent light, respectively.

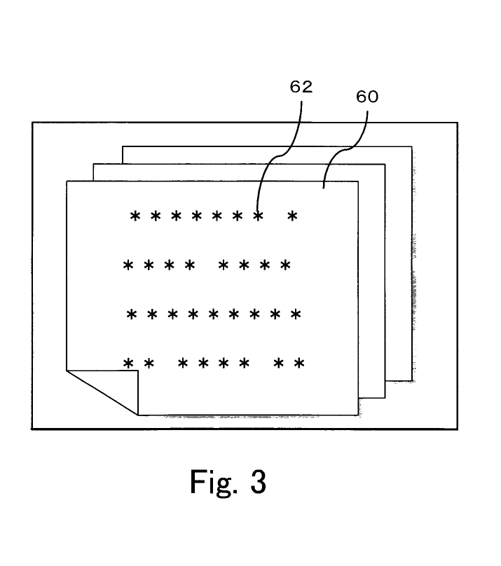

Next, the calculation of the text-scene reliability (hereinafter, referred to as “text reliability Pt”) will be explained. The text scene is an imaging scene suitable for imaging a document. Thus, the presumed target for the text scene is a sheet 60 on which a character string 62 is recorded, as illustrated in FIG. 3. Generally, the sheet is monochromatic (e.g., totally white), and the character string is also monochromatic (e.g., totally black). In other words, it can be said that the document, which is the presumed target for the text scene, is a target having relatively few kinds of colors. Thus, in the present embodiment, the fewer the kinds of colors in the whole preview image, the higher the text reliability Pt is determined to be. More specifically, the average value of the representative color values of the blocks that configure a preview image is calculated, and the more blocks there are whose representative values fall within a specific area with respect to the average value, the higher the text reliability Pt is determined to be.

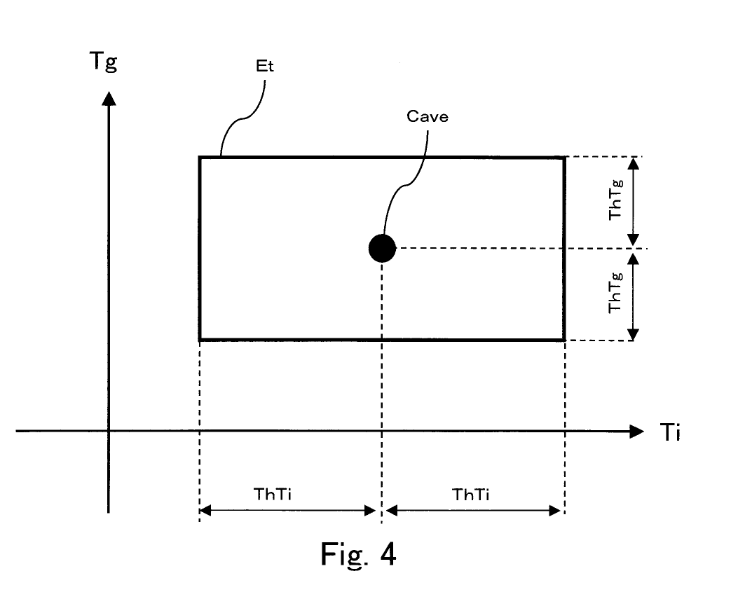

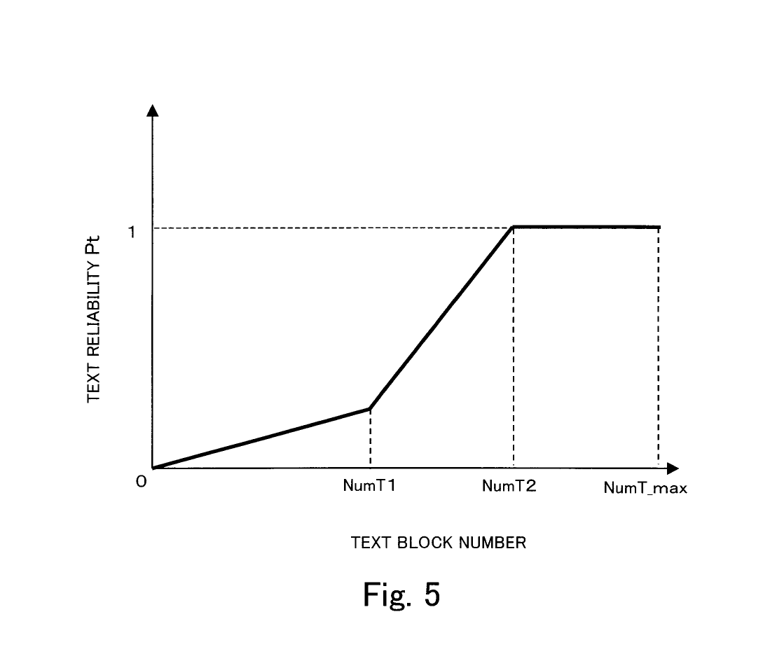

FIGS. 4 and 5 are charts representing how the text reliability Pt is calculated. When the text reliability Pt is calculated, the average value Cave (Tiave, Tgave) of the representative color values of all the blocks that configure a preview image is first calculated. Subsequently, an area which is within ±ThTi, with respect to the average value Cave, along the Ti axis and within ±ThTi, with respect to the average value Cave, along the Tg axis, is set as a text color area Et. In this situation, ThTi and ThTg, which are values for specifying the size of the text color area Et, are preliminarily stored in the internal memory 59, as the scene-characteristics information for the text scene. The respective dimensions of ThTi and ThTg are preliminarily specified based on the color-dispersion amount of an ordinary document.

After the text color area Et is set, the number of blocks, among the blocks that configure the preview image, whose representative color values fall within the text color area Et, is counted as a text block number NumT. It can be said that the larger the text block number NumT, the higher the probability that the target in the preview image has few kinds of colors, or that it is a document.

When the text block number NumT can be counted, the text reliability Pt is then calculated based on the text block number NumT. The text reliability Pt is calculated based on a text reliability curve that is preliminarily stored in the internal memory 59. FIG. 5 is a chart representing an example of the text reliability curve. In FIG. 5, the abscissa denotes the text block number NumT, and the ordinate denotes the text reliability Pt.

As is clear from FIG. 5, in the present embodiment, the larger the text block number NumT is, the higher the text reliability Pt is. This is because the larger the text block number NumT, the higher the probability that the target in the preview image has few kinds of colors, or that it is a document.

In this regard, however, it is conceivable that, in the case where the text block number NumT is the same as or smaller than a specific value, the probability that the target in the preview image is a document is extremely low. Accordingly, in the present embodiment, in the case where the text block number NumT is the same as or smaller than a first reference value NumT1, the gradient of the text reliability curve is made small, as a result of which the sensitivity of text reliability Pt for the text block number NumT is made low. In addition, it can be said that, in the case where almost all blocks among the blocks that configure a preview image are text blocks, the probability that the target in the preview image is a document is very high. Accordingly, in the case where the text block number NumT is the same as or larger than a second reference value NumT2 (NumT2<NumT), it is determined that the text reliability Pt is maximal, i.e., “1”.

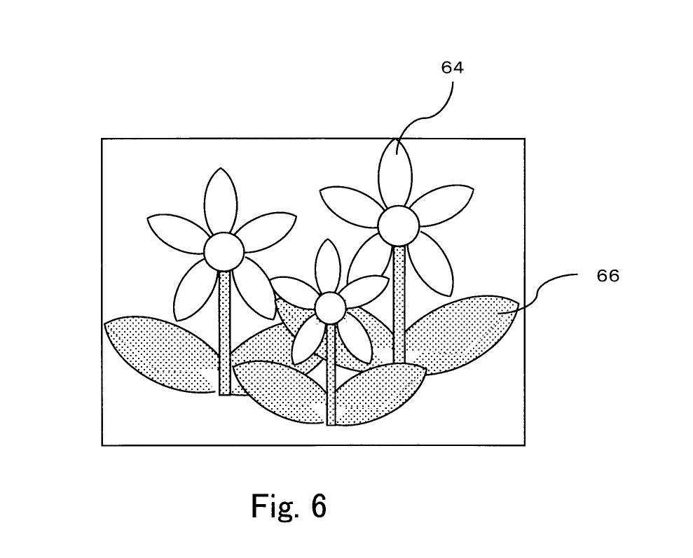

Next, the calculation of the reliability of the flower scene (hereinafter, referred to as “flower reliability Pf”) will be explained. The flower scene is an imaging scene suitable for imaging a flower. It can be said that, as illustrated in FIG. 6, the presumed target in the flower scene is a colorful petal 64 and a greenish leaf or stem 66. In this regard, in the present embodiment, both the probability Pp that a petal exists in a preview image and the probability P1 that a leaf or a stem exists in a preview image are calculated, and then the sum of the probability Pp and the probability P1 are set as the flower reliability Pf (Pf=Pp+P1). Hereinafter, the probability that a petal exists in a preview image and the probability that a leaf or a stem exists in a preview image are referred to as petal reliability Pp and leaf reliability P1, respectively. The petal reliability Pp is calculated based on the total number of blocks that each have the same color characteristic and brightness characteristic as an ordinary petal; the leaf reliability P1 is calculated based on the total number of blocks that each satisfy the same color characteristic and brightness characteristic as an ordinary leaf or the like.

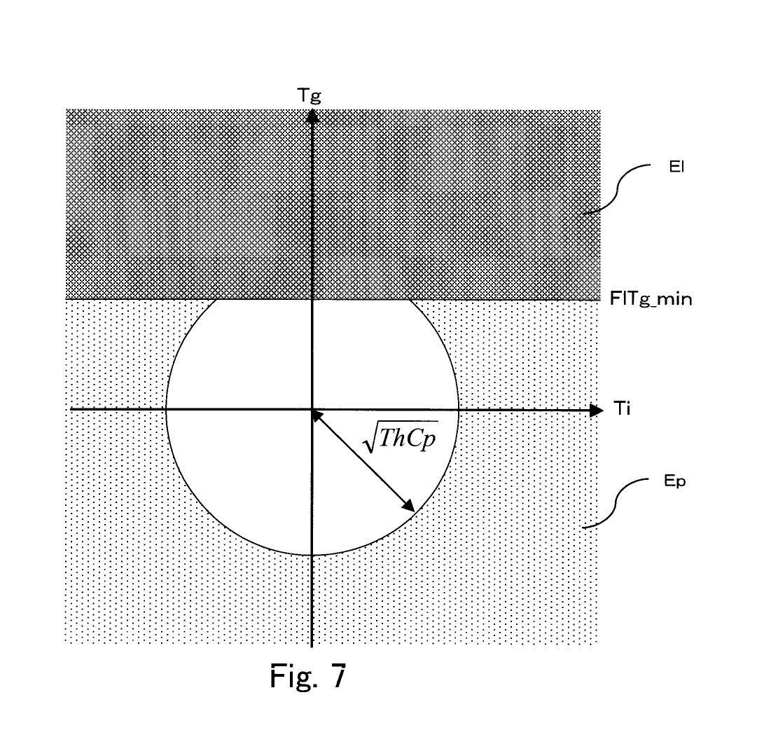

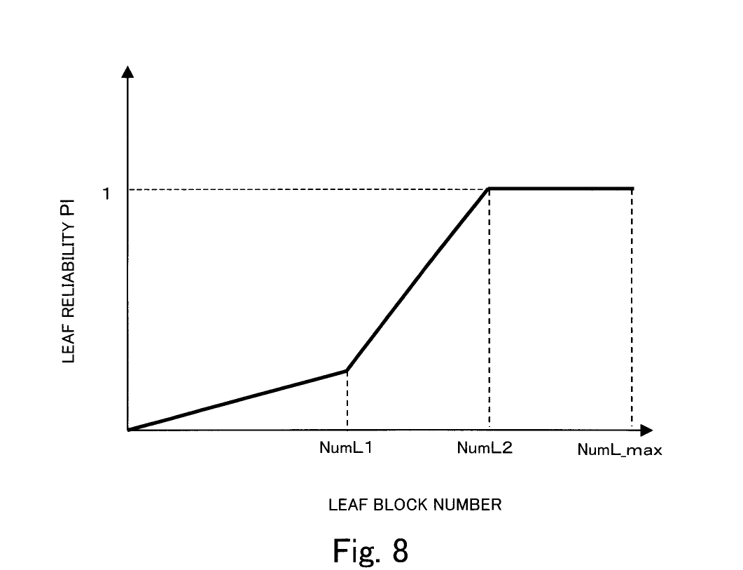

FIGS. 7 and 8 are charts representing how the flower reliability Pf is calculated. As described above, the flower reliability Pf is calculated as the sum of the petal reliability Pp that is the probability that a petal exists in a preview image and the leaf reliability P1 that is the probability that a leaf or a stem exists in a preview image. Thus, here, the calculation of the leaf reliability P1 will be explained first. The leaf reliability P1 is calculated based on the total number of blocks that satisfy the color characteristic and the brightness characteristic of a leaf or a stem. In general, leaves and stems are green-colored or similarly colored and have relatively low brightness. Thus, in the present embodiment, a leaf color area E1 that is the color area of an ordinary leaf or stem and a leaf-brightness reference value Th1 that is the maximal value among the brightness values of ordinary leaves or stems are preliminarily stored, as a leaf characteristic, in the internal memory 59. In this situation, in the present embodiment, an area where Tg values therein fall within the fluorescent-light color area Efl and are situated above the minimal value FlTg_min (refer to FIG. 2) among Tg values in the fluorescent-light color area Efl is set as the leaf color area E1. In other words, in FIG. 7, the dark-black area is the leaf color area E1.

When the leaf reliability P1 is calculated, the total number of blocks, among the blocks that configure a preview image, whose representative color values fall within the leaf color area E1 and whose representative brightness values are smaller than the leaf-brightness reference value Th1, is counted as a leaf block number NumL. Next, the leaf reliability P1 is calculated based on the leaf block number NumL. For the calculation of the leaf reliability P1, as is the case with the calculation of the text reliability Pt, a reliability curve that represents the relationship between the number of blocks and the reliability is utilized. FIG. 8 is a leaf reliability curve representing the relationship between the leaf block number NumL and the leaf reliability P1. As is clear from FIG. 8, the leaf reliability curve is set in such a way that the larger the leaf block number NumL, the higher the leaf reliability P1. Additionally, as is the case with the text reliability curve, the leaf reliability curve increases at a gradual gradient in the case where the leaf block number NumL is smaller than a first reference value NumL1 and at a steep gradient in the case where the leaf block number NumL is the same as or larger than the first reference value NumL1. When the leaf block number NumL is the same as or larger than a second reference value NumL2, the leaf reliability P1 is always “1” that is a maximal value.

Next, the calculation of the petal reliability Pp will be explained. The petal reliability Pp is calculated based on the total number of blocks that satisfy the color characteristic and the brightness characteristic of an ordinary petal. An ordinary petal has a color characteristic of high chroma saturation and a brightness characteristic of being relatively bright. In this regard, in the present embodiment, a petal color area Ep that is the color area of an ordinary petal and a petal-brightness reference value Thp that is the minimal value among the brightness values of ordinary petals are preliminarily stored, as petal-characteristic information, in the internal memory 59. In addition, in the present embodiment, the petal color area Ep is an area where Tg values therein are smaller than the minimal value FlTgFl_min (refer to FIG. 2) among fluorescent-light Tg values, i.e., the minimal value among the Tg values in the leaf color area E1 and where color saturation is high. The color area where color saturation is high may be specified in accordance with various kinds of methods; in the present embodiment, the area excluding the vicinity of the intersection point (zero point) of the Tg axis with the Ti axis is specified as the area where color saturation is high. More specifically, the area where the equation {(Tg value)²+(Ti value)²>ThCp} is satisfied is specified as the area where color saturation is high. Accordingly, in FIG. 7, the thin-black area is the petal color area Ep.

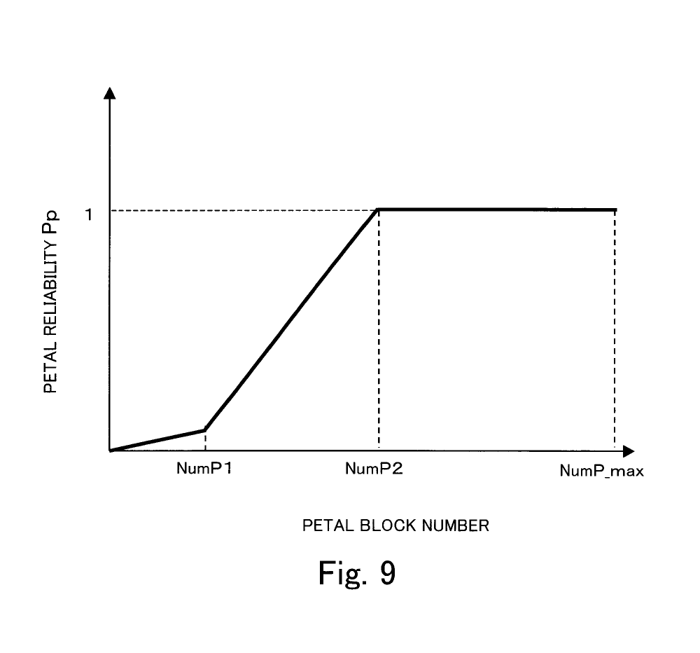

When the petal reliability Pp is calculated, the number of blocks, among the blocks that configure a preview image, whose representative color values fall within the petal color area Ep and whose representative brightness values are the same as or larger than the petal-brightness reference value Thp, is counted as a petal block number NumP. After the petal block number NumP is counted, the petal reliability Pp is calculated based on the petal block number NumP, with reference to a petal reliability curve that is also preliminarily stored. FIG. 9 is a chart representing an example of the petal reliability curve. As is the case with the leaf reliability curve or the like described above, the gradient of the petal reliability curve also changes at a first reference value NumP1 and a second reference value NumP2 as boundary points.

After the leaf reliability P1 and the petal reliability Pp are calculated, the sum of them is calculated. The sum (P1+Pp) of the leaf reliability P1 and the petal reliability Pp is the flower reliability Pf.

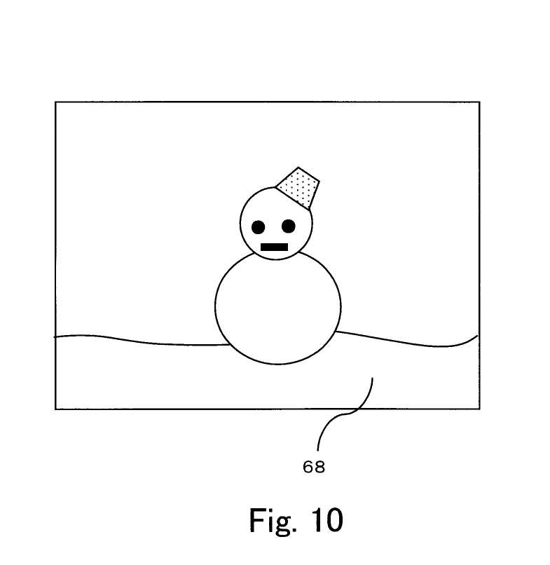

Next, the calculation of the respective reliability levels of the snow scene and the beach scene, i.e., the calculation of snow reliability Ps and beach reliability Pb will be explained. As illustrated in FIG. 10, the snow scene is an imaging scene suitable for imaging on snow. The characteristic target that may definitely exist in the snow scene, i.e., the presumed target, is snow 68. Thus, in the present embodiment, the color characteristic and the brightness characteristic of snow that is the presumed target in the snow scene are stored as the scene characteristic of the snow scene, and then snow reliability Ps is calculated based on the number of blocks having the snow scene characteristic.

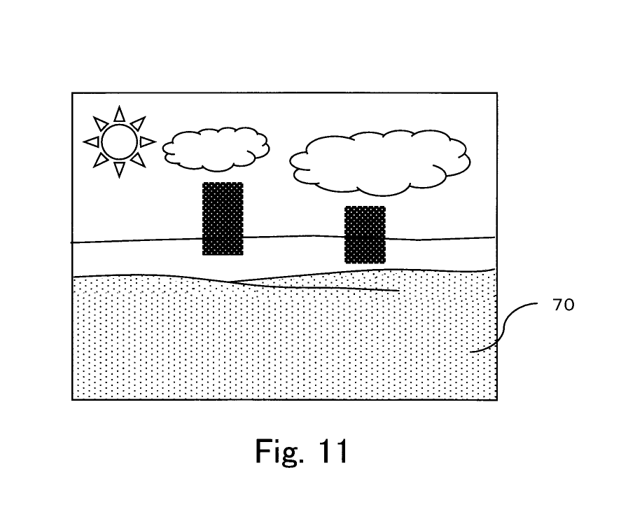

In contrast, as illustrated in FIG. 11, the beach scene is an imaging scene suitable for imaging on a beach. It should be understood that the characteristic target that may definitely exist in the beach scene, i.e., the presumed target, is a beach 70. Thus, in the present embodiment, the color characteristic and the brightness characteristic of the beach are stored as the scene characteristic of the beach scene, and then beach reliability Pb is calculated based on the number of blocks having the beach scene characteristic.

Meanwhile, in general, it is not conceivable that the beach scene and the snow scene concurrently exist. For example, even though the imaging place is a beach, the beach is covered with snow when the snow accumulates. In other words, in the case where a beach exists as a target, snow can never be a target. In summary, the beach scene and the snow scene are established under respective conditions that are contrary to each other. In this regard, in the present embodiment, in the case where the snow reliability Ps indicating the probability that snow exists is higher than zero and the beach reliability Pb indicating the probability that a beach exists is higher than zero, it is determined that the snow reliability Ps and the beach reliability Pb are low in accuracy and dealt with as zeroes.

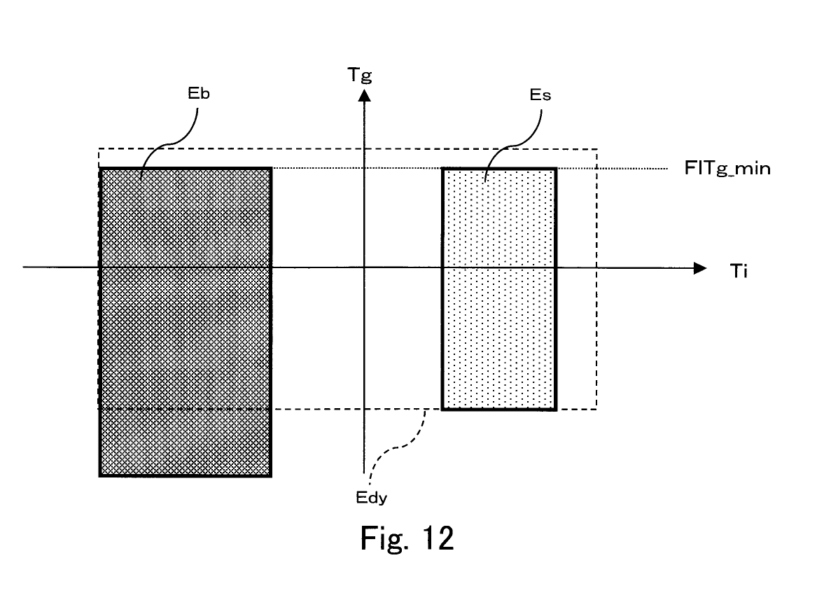

Hereinafter, the calculation of the snow reliability Ps and the beach reliability Pb will be specifically explained. Snow that is the presumed target in the snow scene is high-brightness and whitish. Thus, in the present embodiment, a snow-brightness reference value Ths that is the minimal value among brightness values that snow might have and a snow color area Es that is a color area that snow might have are preliminarily stored, as a scene characteristic for the snow scene, in the internal memory 59. The snow color area Es is an area that falls within the daylight color area (a rectangle Edy in FIG. 2), and in which Ti values are appropriately high and Tg values are the same as or smaller than the minimal value FlTg_min (refer to FIG. 2) among Tg values of the color area of a fluorescent light. Specifically, in FIG. 12, the thin-black area is the snow color area Es.

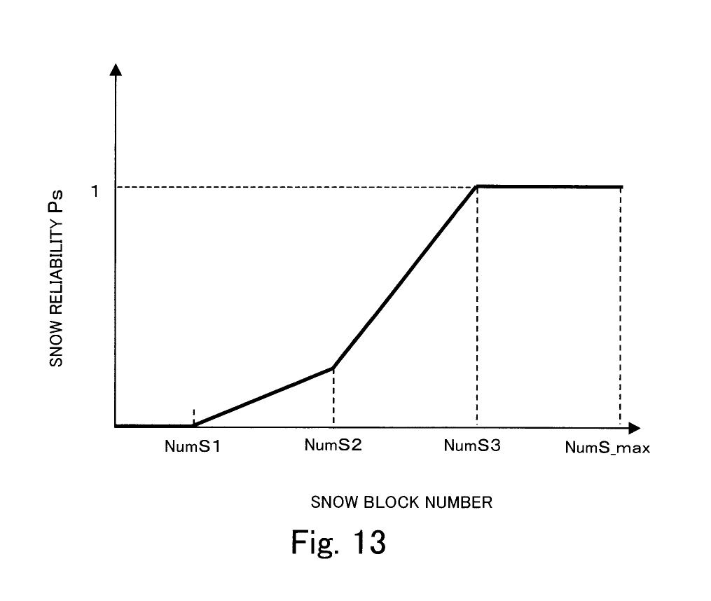

When the snow reliability Ps is calculated, the number of blocks, among the blocks that configure a preview image, whose representative color values fall within the snow color area Es and whose representative brightness values are the same as or larger than the snow-brightness reference value Ths, is counted as a snow block number NumS. Next, the snow reliability Ps is calculated based on the counted snow block number NumS. For the calculation of the snow reliability Ps, as is the case with the foregoing text reliability Pt or the like, a preliminarily stored snow reliability curve is referred to. FIG. 13 is a chart representing a snow reliability curve utilized in the present embodiment.

As is clear from FIG. 13, the snow reliability curve in the present embodiment is set in such a way that the larger the snow block number NumS, the higher the snow reliability Ps. In addition, the snow reliability curve changes its gradient halfway in its course in such a way that, after the snow block number NumS exceeds a specific value (a second reference value NumS2), the sensitivity, of the snow reliability Ps, versus the snow block number NumS is raised. Moreover, in the present embodiment, the snow reliability curve is set in such a way that, in the case where the number of snow blocks is extremely small (the same as or smaller than a first reference value NumS1), the snow reliability Ps becomes zero. The reason why, as described above, in the case where the number of snow blocks is small, the snow reliability is equal to zero, is explained as follows:

As described above, in the present embodiment, in the case where the snow reliability Ps>0 and the beach reliability Pb>0, the snow reliability Ps and the beach reliability Pb, which are calculated based on the snow block number NumS and a beach block number NumB described later, respectively, are rescinded and respecified to be zero. In other words, the condition that the snow reliability Ps>0 and the beach reliability Pb>0 is set as a rescindment condition for rescinding calculated reliability values. The reason why the rescindment condition is set is that the beach scene and the snow scene do not concurrently exist.

Meanwhile, a snow block is a block whose representative brightness value is relatively high and whose representative color value corresponds to a whitish color. In general, blocks having the foregoing characteristics often appear also in an imaging scene other than the snow scene, e.g., in the beach scene, even though the number of such blocks is small. In other words, a case may exist in which, even in the situation where an imaging scene should be determined to be the beach scene, the snow block number NumS>0. In this situation, unless it is specified that the snow reliability Ps=0 in the case where the snow block number NumS is small, the snow reliability Ps and the beach reliability Pb are calculated as values that are larger than zero. In this case, based on the foregoing rescindment condition, the calculated reliability values are rescinded, and it is then determined that the snow reliability Ps=0 and the beach reliability Pb=0. In the present embodiment, in order to prevent unnecessary rescindment of the snow reliability and the beach reliability by the rescindment condition, the snow reliability curve is set in such a way that, in the case where the snow block number NumS is small, the snow reliability Ps becomes zero.

Next, the calculation of the beach reliability Pb will be explained. A beach that is the presumed target in the beach scene is high-brightness and brownish. Thus, in the present embodiment, a beach-brightness reference value Thb that is the minimal value among brightness values that a beach might have and a beach color area Eb that is a color area that a beach might have are preliminarily stored, as a scene characteristic for the beach scene. The beach color area is an area in which Ti values fall within a specific area that is peculiar to a beach and Tg values are the same as or smaller than the minimal value FlTg_min among the Tg values of a fluorescent light. Specifically, in FIG. 12, the thick-black area is the beach color area Eb.

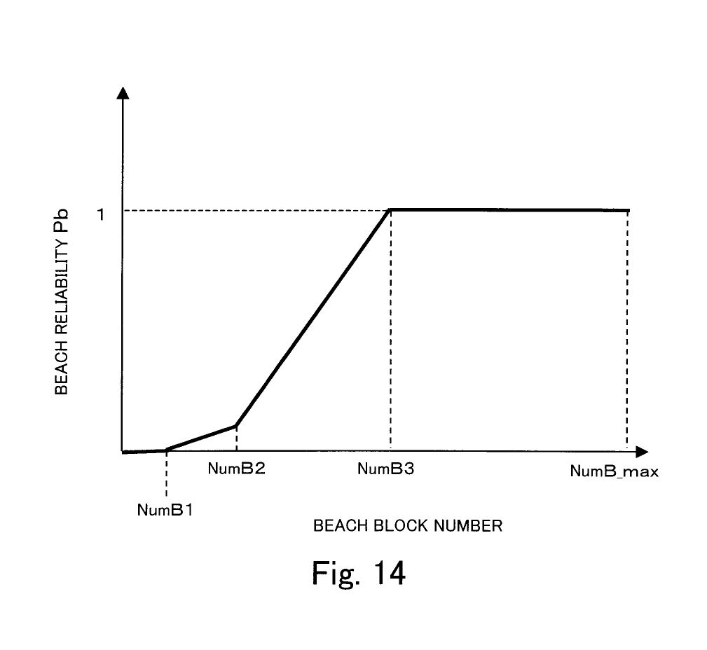

When the beach reliability Pb is calculated, the number of blocks, among the blocks that configure a preview image, whose representative color values fall within the beach color area Eb and whose representative brightness values are the same as or larger than the beach-brightness reference value Thb are counted as a beach block number NumB. Next, the beach reliability Pb is calculated based on the counted beach block number NumB. For the calculation of the beach reliability Pb, as is the case with the foregoing text reliability Pt or the like, a preliminarily stored beach reliability curve is referred to. FIG. 14 is a chart representing a beach reliability curve utilized in the present embodiment.

As is clear from FIG. 14, the beach reliability curve in the present embodiment is set in such a way that the larger the beach block number NumB, the higher the beach reliability Pb. In addition, the beach reliability curve changes its gradient halfway along its course. Moreover, in the present embodiment, the beach reliability curve is set in such a way that, in the case where the beach block number NumB is small (the same as or smaller than a first reference value NumB1), the beach reliability Pb is zero. The reason for this is the same as the fact that, in the case where the snow block number NumS is small, the snow reliability is made to be zero.

After the snow reliability Ps and the beach reliability Pb are calculated, the scene reliability calculation unit 54 determines whether or not the rescindment condition, and Ps>0 and Pb>0 are satisfied. In the case where the rescindment condition is satisfied, the calculated values of the snow reliability Ps and the beach reliability Pb are rescinded, set to be zero, and then recalculated. In the case where the rescindment condition is not satisfied, the values of the snow reliability Ps and the beach reliability Pb that are calculated based on the respective reliability curves are maintained.

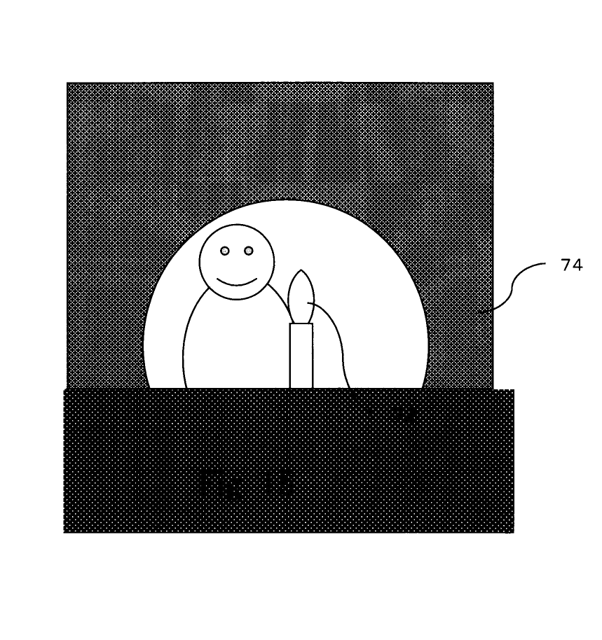

Next, the calculation of the reliability of the candlelight scene, i.e., candle reliability Pc, will be explained. As illustrated in FIG. 15, the candlelight scene is an imaging scene suitable for imaging in the light of a candle 72. In the candlelight scene, the characteristic target that is presumed to always exist, i.e., the presumed target is the lit candle 72. Additionally, in the case where the candle 72 exists, it is presumed that the preview image has the following color and brightness characteristics.

In the first place, the color of candlelight is similar to that of tungsten light, i.e., relatively reddish. In other words, in the case where a lit candle exists, the color value of a block, among blocks in the preview image, whose brightness is maximal should be relatively reddish. Additionally, the light amount of candlelight is small compared with those of other light sources such as an electric incandescent lamp and a fluorescent light. Accordingly, in the case where a lit candle exists, low-brightness blocks 74, among blocks in the preview image, at which the candlelight does not arrive should exist in a great number. In summary, it can be said that, in the case where the maximal-brightness block has a color similar to that of tungsten light and the low-brightness blocks have a significant area, the imaging scene is the candlelight scene.

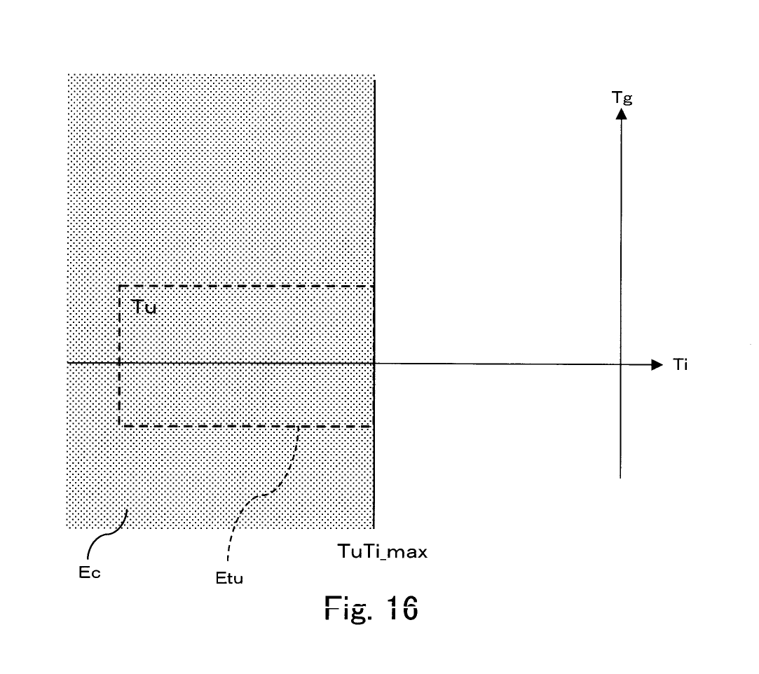

Next, in the present embodiment, the calculation of the candle reliability Pc will be calculated in accordance with the following procedure: In the first place, the maximal-brightness block among the blocks that configure a preview image is identified. Secondly, it is determined whether or not the representative color value of the maximal-brightness block falls within a candle color area Ec. The candle color area Ec is a color area that candlelight might have in general. The candle color area Ec is preliminarily stored in the internal memory 59 as the scene characteristic of the candlelight scene. The candle color area Ec is an area in which Ti values are the same as or smaller than the maximal value TuTimax among the Ti values of tungsten light. Specifically, in FIG. 16, the thin-black area is the candle color area Ec. Additionally, in FIG. 16, the rectangle illustrated by a broken line indicates a tungsten-light color area Etu.

It can be determined that, in the case where the representative color value of the maximal-brightness block does not fall within the candle color area Ec, the probability that a lit candle exists in the preview image is extremely low. Thus, in this case, it is determined that the candle reliability Pc is zero.

In contrast, in the case where the representative color value of the maximal-brightness block falls within the candle color area Ec, the number of blocks whose representative brightness values are the same as or smaller than a predetermined low-brightness reference value Thcan is then counted as a low-brightness block number NumC. In this situation, the low-brightness reference value Thcan is set at a brightness value that is relatively low, i.e., that may be visually determined to be approximately dark.

After a low-brightness block number NumC is counted, it is then determined whether or not the low-brightness block number NumC is the same as or larger than a predetermined reference number ThNum. The predetermined reference number ThNum is the minimal value among the numbers of low-brightness blocks that might exist in an ordinary candlelight scene. In the case where the low-brightness block number NumC is smaller than the predetermined reference number ThNum, it is anticipated that a light source, other than a candle, having a relatively high light amount is utilized. Thus, in this case, it is determined that the candle reliability Pc is zero.

In contrast, in the case where the representative color value of the maximal-brightness block falls within the candle color area Ec and the low-brightness block number NumC is the same as or larger than the predetermined reference number ThNum, the candle reliability Pc is calculated based on the following equation (2).

Pc=BrTi/TuTi_max (2)

where BrTi is the Ti value of the maximal-brightness block and TuTi_max is the maximal value (refer to FIG. 16) among the Ti values of tungsten light. In other words, in the present embodiment, it is determined that the closer the Ti value of the maximal-brightness block, among the Ti values of tungsten light, is to the maximal value TuTi_max, the higher the candle reliability Pc.

The scene reliability levels for the respective scenes, calculated in accordance with the foregoing procedures described heretofore, are inputted to the scene determination unit 56 and utilized for automatic scene determination. As is clear from the foregoing explanation, each scene reliability is an index that, for each imaging scene, indicates whether or not the characteristic target exists. The use of the foregoing scene reliability enables various situations, which have not been readily determined based only on a target distance and environmental brightness, to be distinguished from one another, whereby high-accuracy determination of the respective image scenes suitable for the various situations can be performed. In other words, the present embodiment enables more accurate automatic scene determination, and ultimately, more appropriate imaging.

In addition, the scene reliability is a value for presuming the probability of the existence of the presumed target, based on color characteristics and brightness characteristics. Accordingly, it is anticipated that a case exists in which the scene reliability levels of two or more imaging scenes are all high. For example, in many cases, in the snow scene suitable for imaging in the snow, the number of colors is small. The color characteristic that the number of colors is small is also applied to the text scene. Accordingly, a case also exists in which the snow reliability Ps and the text reliability Pt are both calculated as high values. However, the snow scene and the text scene can be distinguished from each other, based on information other than the scene reliability, e.g., a target distance or the like. Accordingly, even the case in which two or more imaging scenes are all high does not pose any problem.

Moreover, in the case where two or more imaging scenes are all calculated as high values, the two or more imaging scenes may be proposed to the user as candidates for preferred imaging scenes suitable for the current situation.

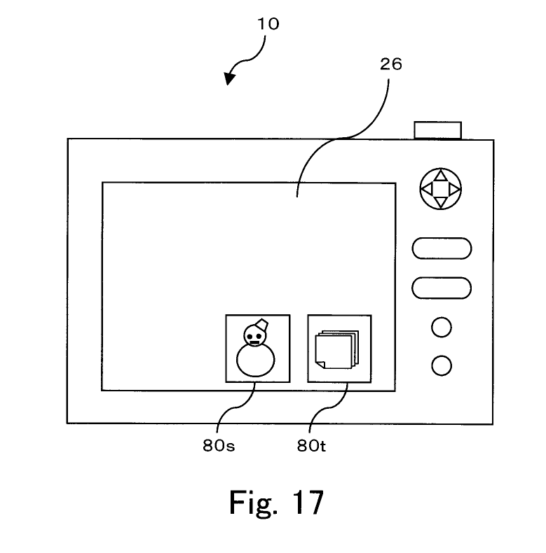

In other words, in the case where the snow reliability Ps and the text reliability Pt are both high values, an icon 80s indicating the snow scene and an icon 80t indicating the text scene may be displayed on part of the LCD 26, as illustrated in FIG. 17. Additionally, by making it possible to, when the user selects the imaging scene, preferentially select the snow scene or the text scene whose reliability is high, the user's operation at the moment when the imaging scene is selected can be simplified.

### PARTS LIST

camera
diaphragm member
lens
CCD
correlated double sampling (CDS)
amplifier (AMP)
A/D converter
image processing unit
LCD
timing generator
compression/expansion circuit
recording medium
CPU
operation unit
RGB separation unit
γ-correction section
processing section
color correction section
block-characteristic unit
WB gain calculation unit
scene-reliability calculation unit
scene determination unit
scene setting unit
internal memory
sheet
character string
petal
leaf
snow
beach
candle
low-brightness block

1. A digital camera in which an imaging scene suitable for a current imaging situation can be selected among a plurality of predetermined imaging scenes and set as a preferred scene, the digital camera comprising:
an imaging unit which optoelectrically performs conversion of a target image focused by an imaging optical system so as to obtain a captured image;
a block dividing unit which divides the captured image into a plurality of blocks and calculates as block characteristics a representative brightness value and a representative color value of each block;
a storage unit which, for each imaging scene, preliminarily stores as scene characteristics at least one of a color characteristic and a brightness characteristic of a presumed target which is a characteristic target in each imaging scene; and
a reliability calculation unit which, for each imaging scene, calculates as captured image, based on a comparison between the block characteristics and the scene characteristics.

2. The digital camera according to claim 1, wherein the reliability calculation unit calculates the scene reliability, based on the number of blocks, among the plurality of blocks that configures the captured image, that each have the same characteristics as the scene characteristics.

3. The digital camera according to claim 1, wherein the scene characteristics includes a color area and a brightness area of the presumed target, and the reliability calculation unit calculates the scene reliability, based on the number of blocks, among the plurality of blocks that configures the captured image, whose representative color values fall within the color area of the presumed target and whose representative brightness values fall within the brightness area of the presumed target.

4. The digital camera according to claim 1, wherein, with regard to an imaging scene in which a plurality of presumed targets exist that have color characteristics that are different from one another and brightness characteristics that are different from one another, the storage unit stores, as the scene characteristic of the imaging scene, the color characteristic and the brightness characteristic of each presumed target, as target characteristics, and the reliability calculation unit calculates probability level of existence of each presumed target, based on the number of blocks that each have the same characteristics as the target characteristics of said presumed target, and calculates the scene reliability based on the sum of the calculated probability levels for each presumed target.

5. The digital camera according to claim 1, wherein, in the case where scene reliability levels, calculated based on the number of blocks, for two or more imaging scenes that are established under respective conditions that are contrary to one another are all the same as or higher than a specific reference value, the reliability calculation unit makes all the scene reliability levels of the two or more imaging scenes zero.

6. The digital camera according to claim 1, wherein, as the scene characteristic of a candlelight scene suitable for imaging in candlelight, the storage unit stores a color area of candlelight, a low-brightness block number that is the number of low-brightness blocks, and a color reference value of candlelight, and in the case where the representative color value of a maximal-brightness block among the plurality of blocks that configures the captured image falls within the color area of candlelight and number of the low-brightness blocks is the same as or larger than the low-brightness block number, the reliability calculation unit calculates the scene reliability, based on the ratio of the representative color value of a maximal-brightness block to the color reference value of candlelight.

7. The digital camera according to claim 1, further comprising a imaging scene for which scene reliability that is the same as or higher a specific reference value is calculated.
